(19) United States
(12) Patent Application Publication
(10) Pub. No.: US 2012/0059661 A1
(43) Pub. Date: Mar. 8, 2012

(54) Maintaining and Using a Lost Item Database

(76) Inventors: Brian Colodny, Reno, NV (US); Michael McLaughlin, Gardnerville, NV (US)

(21) Appl. No.: 13/224,247

(22) Filed: Sep. 1, 2011

Related U.S. Application Data
(60) Provisional application No. 61/379,687, filed on Sep. 2, 2010.

(51) Int. Cl. G06Q 10/00

(52) U.S. Cl. 705/1.1

(57) ABSTRACT

In one embodiment, a system and method for monitoring lost items, includes a database configured to store lost item information, the lost item information pertaining to lost items recovered at one or more establishments; and a computing device operatively connected to the database, the computing device operable to: (i) receive lost item information for a given lost item that has been recovered at the one or more establishments; (ii) entry of a lost item record for the given lost item into the database, the lost item record includes the lost item information for the given lost item; (iii) browse or search the database to locate lost item of a current or prior patron of the one or more establishments; and (iv) facilitating transmission of an electronic recovery notification to the current or prior patron when the lost item of the current or prior patron has been located in the database.

### CROSS-REFERENCE TO RELATED APPLICATION

This application claims priority to U.S. Provisional Patent Application No. 61/379,687, filed Sep. 2, 2010 and entitled “System And Method For Inventory And Return Of Lost Items,” which is hereby incorporated herein by reference in its entirety.

### BACKGROUND OF THE INVENTION

Everyone has forgotten a personal item at least once. Once lost, the items may or may not ever be returned to the rightful owner. For example, when on vacation, a user may forget an item(s) in a hotel room. In another example, a customer may forget an item in a rental car, sporting event, or any other establishment or event. The most common item left in hotel rooms is chargers, such as a cell phone charger. However, any other valuable items may also be lost or left behind such as clothing, cell phones, jewelry, and the like. Typically hotel personnel simply toss the lost charger in a lost-and-found box at the front desk, wait for a phone call from the customer, then rummage through the lost-and-found box to see if the description provided by the customer matches any charger they have in the lost-and-found box.

Hotel personnel then need to contact a shipping company, such as FedEx, UPS, or package the item and drop it off at a post office. The guest is typically charged for the return of their lost item, which is typically very expensive since the hotel does not have a favorable shipping rate. Since the process is laborious and costly, either the hotel simply does not make the effort to return the lost item to the customer and/or the customer decides to forgo the lost item to simply buy a new item at a lower cost.

### SUMMARY

Embodiments of the invention allow users to recover their lost items in a cost effective and efficient manner from an establishment. Since many of the processes are automated and more cost effective, the cost of shipping is lower than the cost to replace the lost item. As such, a consumer (and establishment) may be more inclined to have their lost items returned rather than buying a new one. The establishment may transmit a lost item report and a client may transmit a recovery item request to a recovery server. The lost item report and the recovery item request may be compared to determine whether there is a match. If there is a match, a shipper may be notified and shipping information may be transmitted to the establishment and the client to notify them that the lost item has been found and when it will be returned to the client. For example, a website may be used to report, query, and notify clients of the existence of a lost item. In another example, embodiments may evaluate and determine the disposition of the lost item and return the lost item to the client. In still another example, embodiments may query the lost item database for the current status of a lost or recovered item as well as access a complete chain of custody.

In one embodiment, a system for monitoring lost items comprises a database configured to store lost item information, the lost item information pertaining to lost items that have been recovered at one or more establishments; and a computing device operatively connected to the database. The computing device operable to receive (i) lost item information for a given lost item that has been recovered at the one or more establishments; (ii) entry of a lost item record for the given lost item into the database, the lost item record includes the lost item information for the given lost item; (iii) browse or search the database to locate lost item of a current or prior patron of the one or more establishments; and (iv) facilitating transmission of an electronic recovery notification to the current or prior patron when the lost item of the current or prior patron has been located in the database.

In another embodiment, a method for maintaining a database pertaining to lost items includes providing a database configured to store lost item information, the lost item information pertaining to lost items that have been recovered at one or more establishments. The method also provides for displaying a first graphical user interface that facilitates receipt of lost item information for a given lost item and entry of a lost item record for the given lost item into the database, the lost item record includes the lost item information for the given lost item. Subsequently, a second graphical user interface for initiating a search of the database to locate a missing item of a current or prior patron of the one or more establishments is displayed and a status of the lost item is updated provided that the searching locates the lost item in the database.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIG. 1 illustrates an example system for the return of lost items.

FIGS. 2A and 2B illustrate is an example method for recovering lost items.

FIG. 3 illustrates an example of a client-side method for recovering lost items.

FIGS. 4A-4C illustrates another example of a method for recovering lost items.

FIG. 5 illustrates an example screen shoot of a log-in screen.

FIGS. 6A-6B illustrate example screen shots of a lost item report.

FIGS. 7A-7C illustrate example screen shot for reports and services provided by recovery server.

FIGS. 8A-8B illustrate example screen shots of a recovery notification.

FIGS. 9A-9C illustrate example screen shots of responses to a selection of the recovery notification.

FIG. 10 illustrates a same screen shot of a payment method.

FIG. 11 illustrates a screen shot of an example alert notification.

FIGS. 12A and 12B illustrate example shipping documents.

FIG. 13 illustrates an example detailed lost item report.

FIGS. 14A-14B illustrate example screen shots of shipment notifications.

FIGS. 15A and 15B illustrate example screen shots of a recovery item request.

FIG. 16 illustrates an example coupon provided by an establishment.

FIG. 17 illustrates a block diagram of a computing device according to one embodiment.

### DESCRIPTION OF EXAMPLE EMBODIMENTS

Embodiments are described herein in the context of a system and method for inventory, notification, and return of the lost items. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Embodiments of the invention allow users to recover their lost items in a cost effective and efficient manner from an establishment. Since many of the processes are automated and more cost effective, the cost of shipping is lower than the cost to replace the lost item. As such, a consumer (and establishment) may be more inclined to have their lost items returned rather than buying a new one. The establishment may transmit a lost item report and a client may transmit a recovery item request to a recovery server. The lost item report and the recovery item request may be compared to determine whether there is a match. If there is a match, a shipper may be notified and shipping information may be transmitted to the establishment and the client to notify them that the lost item has been found and when it will be returned to the client. For example, a website may be used to report, query, and notify clients of the existence of a lost item. In another example, embodiments may evaluate and determine the disposition of the lost item and return the lost item to the client. In still another example, embodiments may query the lost item database for the current status of a lost or recovered item as well as access a complete chain of custody.

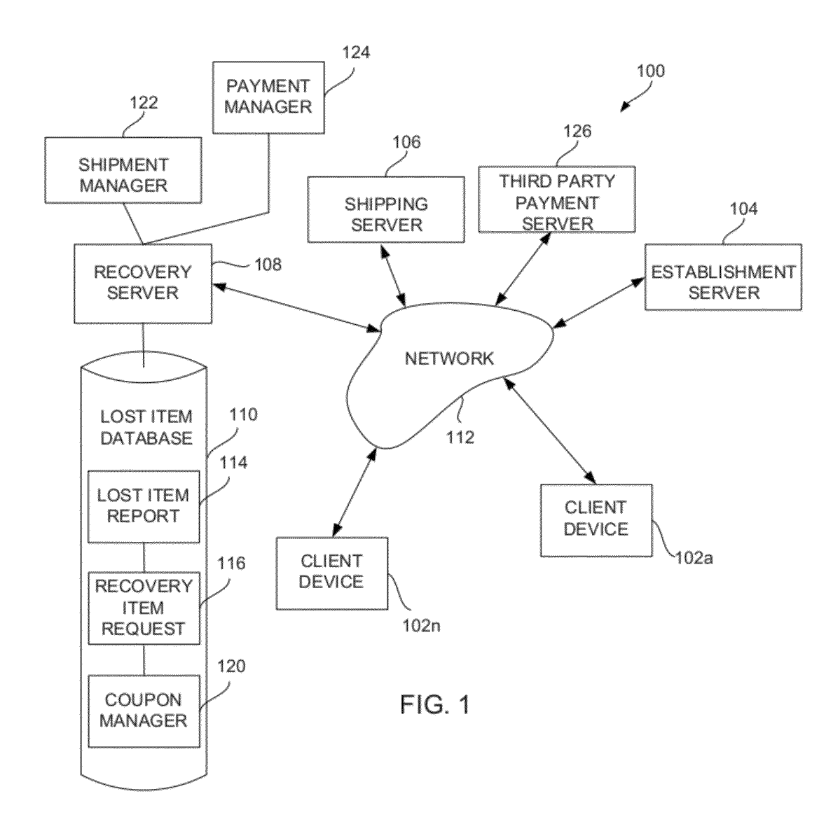

Several embodiments of the invention are discussed below with reference to FIGS. 1-17. However, those skilled in the art will readily appreciate that the detailed description given herein with respect to these figures is for explanatory purposes as the invention can extend beyond these limited embodiments.

FIG. 1 illustrates an example system for the return of lost items. The system 100 can have a plurality of client computing devices 102a, 102n (where n is an integer) configured to communicate with a recovery server 108 via network 112 to transmit a recovery item request with the hope of recovering their lost items. Client computing devices 102a-n and recovery server 108 may be connected to network 112 via any known wired or wireless manner. Client computing devices 102a-n may be any computing device such as a desktop computer, laptop, netbook, as well as any mobile computing device such as mobile (e.g., cellular) phones, media players, personal digital assistants (PDAs), and the like.

The system 100 may have an establishment server 104 configured to communicate with the recovery server 108 via network 112 to transmit lost item reports and conduct any other transactions such as receive shipping documents, authentication of the customer, and the like. The establishment server 104 may be associated with any type of business such as a hotel, supermarket, airport, airline company, coffee shop, car rental company, school (e.g. primary school, university, college, and the like), cruise ship, movie theaters, parks and campgrounds, shopping centers, business centers, private residences, or any other location where a lost item may be found. Furthermore, the establishment server may also be an event, such as a football game, convention, seminar, and the like.

Recovery server 108 may have a lost item database 110 to store lost item reports 114. In one embodiment, the lost item reports 114 may be transmitted from the establishment server 104 to the recovery server 108. In another embodiment, the lost item reports 114 may be transmitted from the client device 102a-n to the recovery server 108. The lost item report 114 may include lost item description such as the location of where the item was found, detailed description of the item, such as color, shape, manufacturer, client contact information, current storage location of the lost item and other descriptive information. The location of where the item was found may include a business name, room number, seat number, and/or additional location data of where the item was located. The lost item description may also include an image of the lost item to enhance or increase the chances for identification of the lost item.

When a customer calls the establishment to report a lost item or if the customer themselves reports the lost item electronically, the lost item and the customer may be matched using any known match validation methods. For example, in one embodiment, the establishment server may create and transmit to the recovery server 108 a lost item request. In another example, the client 102a-n may self-report the lost item using a recovery item request. The recovery item request 116 may be stored in the lost item database 110. The recovery item request 116 may include the same or similar categories as in the lost item reports 114. For example, the recovery item request 116 may include recovery item descriptions such as the location of where the item was lost, detailed description of the item, such as color, shape, additions, client contact information, and other descriptive information. The location of where the item was lost may include a business name, room number, seat number, and/or additional location data of where the item was lost. The recover item request may also include an image of the lost item to enhance or increase the chances for identification of the lost item. The example embodiments of the match validation method insure that the item is returned to the rightful owner.

The lost item description and the recovery item description may be sorted and stored in a table or in any other format in lost item database 110. A data structure of the lost item description and the recovery item description may be compared to determine whether there is a match. Any known comparison method may be used to compare the lost item description and the recovery item description in the lost item database 110. For example, if a first image is associated with the lost item report and a second image is associated with the recovery item report, the images may be scanned and compared. Based upon the match percentage resulting from the image scan, the lost item may be recovered. For example, if the match percentage is greater than 75%, then there is a high probability that the lost item may be located.

In one embodiment, a timestamp may be provided for each item in the database so that after a predetermined amount of time (e.g. 30 days, 3 months, 6 months), older lost item reports 114 and recovery item requests 116 may be removed and deleted.

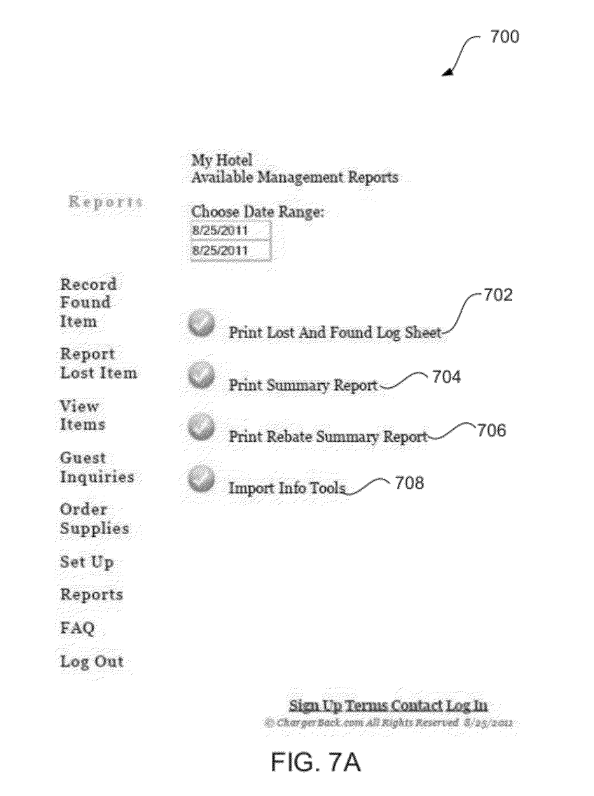

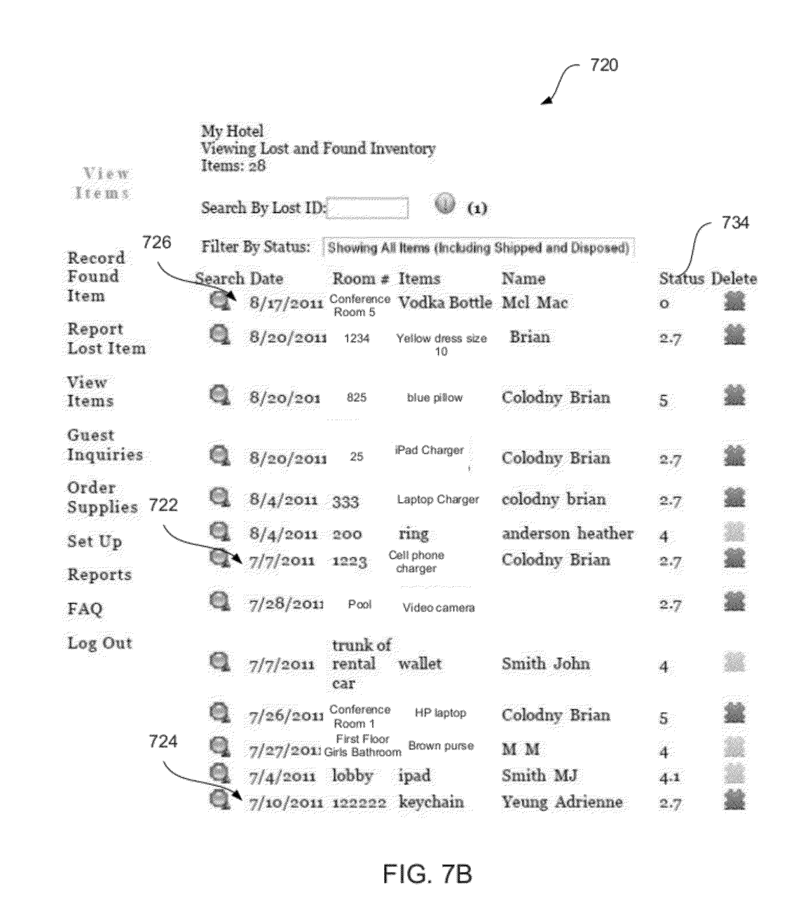

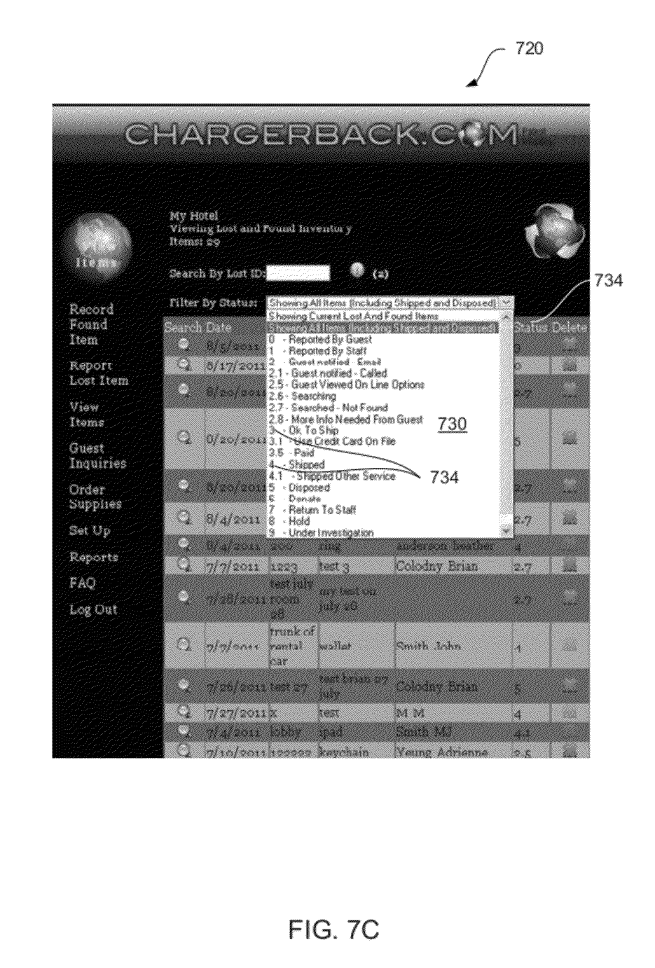

In other embodiments, the lost item and the customer may be matched by using a filter (as illustrated in FIG. 7C), keyword search, and other match methods. Once there is a match, the lost item may then be referred to as a recovered item. In another embodiment, allowing the client and/or establishment to upload an image of the lost item may enhance the identification of the lost item. The image of the lost item may be associated with a lost item report and/or a recovery item request, such as with a pointer or any other association methods.

Referring back to FIG. 1, lost item database 110 may have a coupon manager 120. The coupon manager may be configured to generate and transmit a customized coupon to the establishment server 104 and/or client device 102a-n. The coupon may be customized to the establishment such as including the establishment logo, tag lines, colors, and any other indicia necessary or desired by the establishment to customize the coupon. The coupon may be provided to customer or client 102a-n to provide a discount on the return of their lost times, such as a discount on shipping costs, hotel stays, buffet, show tickets, and the like. The coupon may be provided to the client at different times. In one example, the coupon may be transmitted to the client device 102a-n concurrently with, before, or after a recovery notification is transmitted to client device 102a-n. In another example, a physical coupon may be provided to the customer upon check-in at the establishment or event. The physical coupon may have a coupon code that the customer may enter to obtain the discount. In still another example, the coupon may be provided to the client device 102a-n after logging into a website. In yet another example, the coupon may be included in the return shipment of the recovered item.

In one embodiment, recovery server 108 may transmit a recovery notification to client 102a-n to inform client 102a-n that their lost item has or had not been found. In one embodiment, the notification may include a customized and/or personalized message to the client 102a-n. For example, the notification may include a customized pre-formatted response that is transmitted to the client. In another example, the message may be a text, audio, attachment or any other type of notification message. In still another embodiment, after a pre-determined period of time (e.g. 30 days, 2 months, 3 months, and the like) the customized and/or personalized message may be a notification to the client 102a-n that the item was not recovered.

The recovery server 108 may monitor the recovery notification (or any other transmission to the client 102a-n) to determine whether and when the client or customer 102a-n viewed the recovery notification. When the client 102a-n has viewed the recovery notification, the status indicator (as discussed with reference to FIG. 7C) may automatically be updated to reflect that the customer was contacted. Additionally, the recovery server 108 may notify the establishment sever 104 that the client 102a-n was notified.

If the lost item was recovered, the recovery notification may include an option to have the lost item shipped to back to client 102a-n, held at the establishment for pick-up by client 102a-n, or a rejection to not have the lost item shipped back to client 102a-n. If client 102a-n selected to have the recovered item held at the establishment for pick-up by client 102a-n, recovery server 108 may transmit a hold request to establishment sever 104. If client 102a-n selected to not have the recovered item returned, recovery server 108 may transmit a rejection notification to establishment sever 104.

If client 102a-n selected to have the recovered item shipped back to them, in one embodiment, recovery server 108 may transmit shipping and payment options to client 102a-n. The customer or client 102a-n may then select the preferred shipping method (as further discussed below) and provide payment information to pay for shipping costs. The shipping method may also include different shipping options such as the purchase of insurance, delivery confirmation, expedited delivery, and the like. In one example, the client 102a-n may pay for the shipping costs using a credit card. In another example, the client 102a-n may have a promotional code provided by establishment or another third party to use to pay for or discount the shipping costs.

Recovery server 108 may have a payment manager 124 configured to conduct financial transactions such as obtain customer financial information, verify credit card payments, and the like. In on embodiment, payment manager 124 may be configured to communicate with third party payment server 126 to conduct the financial transactions. In another embodiment, payment manager 124 may perform the financial transactions without the use of a third-party payment server. Upon payment of the shipping costs, recovery server 108 may transmit the shipping selection and payment notification to establishment server 104.

Although illustrated with the use of payment manager 124 and third party payment server 126, this is not intended to be limiting as payment for the shipping costs may be conducted by other methods. For example, establishment 104 may contact client 102a-n directly to have the costs charged to a credit card on file at the establishment 104. In another example, establishment 104 may obtain payment information directly from client 102a-n. In yet another example, establishment 104 may have an open billing account to charge the shipping costs to.

Recovery server 108 may also have a shipment manager 122 configured to communicate with shipping server 106 via network 112. Shipping server 106 may be any company that performs shipping services such as UPS™, United States Postal Service, DHL™, FedEx™, common carrier, local delivery service, or any other company that provides similar services. If a lost item is matched with its customer, shipment manager 122 may be configured to transmit a shipping request to shipping server 106 via network 112. The shipping request may include a request for shipping documents and/or information such as a tracking number, cost and/or bill, receipt, and any other shipping information and/or documents. Shipping server 106 may transmit the requested shipping documents to shipping manager 122 via network 112. Once shipping manager 122 receives the shipping documents, the shipping documents may be transmitted to establishment server 104. The shipping documents may be transmitted by any known means, for example via electronic mail, text, and the like. In another example, establishment can log into a website associated with the recovery server and access the shipping documents and/or information from the website.

Establishment server 104 may then be able to print shipping labels (i.e. plain paper or label stock), assign a tracking number, print a receipt for billing purposes, and conduct any other requirements to efficiently ship the recovered item to the customer or client 102a-n. Establishment sever 104 may then notify shipping server 106 that the package or shipment needs to be picked up at the establishment 104 by any known methods such as electronic mail, text message, use of the shipment company's web page, telephone call, or any other notification methods. In one embodiment, the printing of the shipping documents may automatically notify the shipping server that a package is ready for pickup at establishment.

Once the recovered item is shipped, establishment server 104 may transmit a shipped notification directly to client 102a-n and/or recovery server 108 to inform client 102a-n that the recovered item has been shipped. The shipped notification may also allow the client 102a-n to track the shipment at shipping server's 106 website.

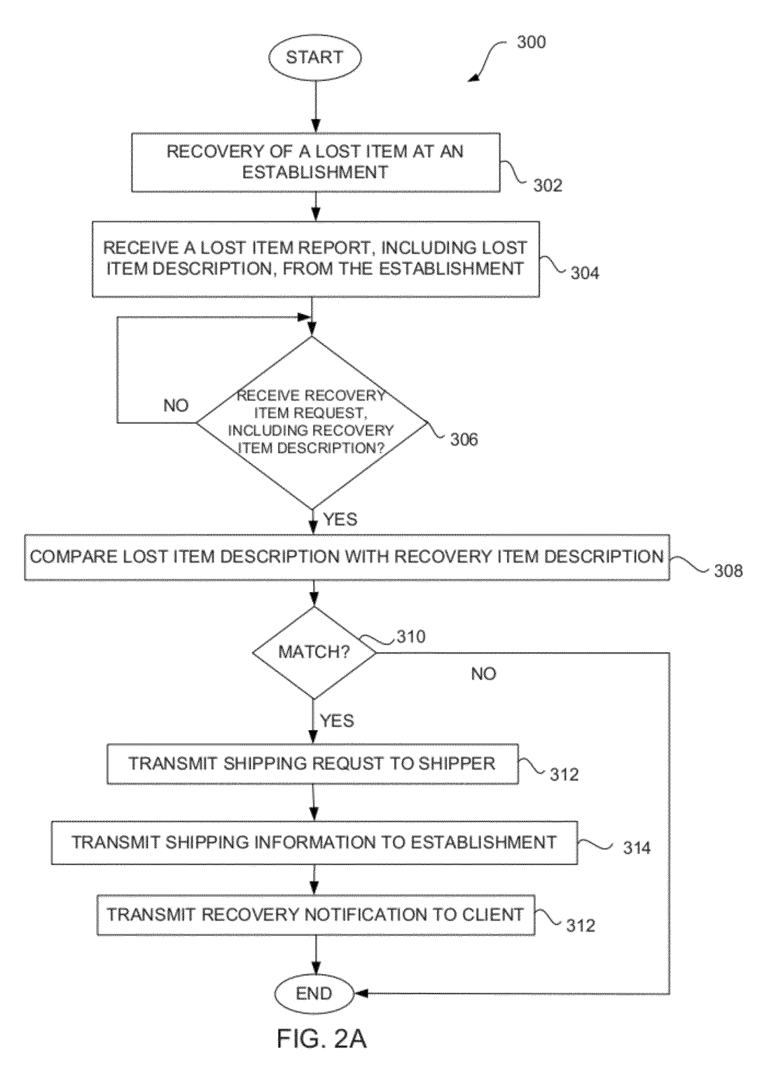

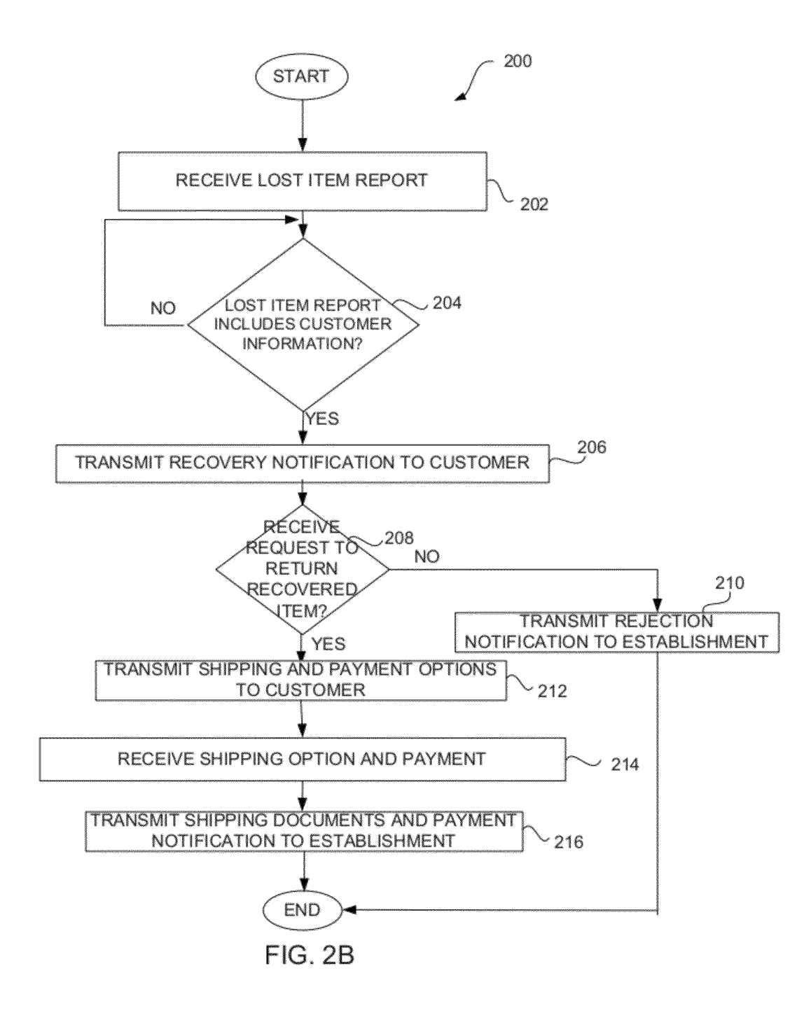

FIGS. 2A and 2B illustrate is an example method for recovering lost items. Referring to FIG. 2A, the method 300 may start with the recovery of a lost item at an establishment at 302. A lost item report, including lost item description, may be received at a recovery server at 304. Lost item description may include lost item description such as the location of where the item was found, detailed description of the item, such as color, shape, manufacturer, client contact information, current storage location of the lost item, and other descriptive information. The lost item description may also include an image of the lost item to enhance or increase the chances for identification of the lost item.

If a recovery item request, including recovery item description, is received at 306, the lost item description and recovery item description are compared at 308. The recovery item description may include description such as the location of where the item was lost, detailed description of the item, such as color, shape, manufacturer, client contact information, and other descriptive information. The lost item description may also include an image of the lost item to enhance or increase the chances for identification of the lost item. The recovery item request may be completed and transmitted via the establishment server (e.g. establishment server 104 illustrated in FIG. 1) or completed and transmitted via the recovery server (e.g. recovery server 108 illustrated in FIG. 1).

If no recovery item request is received at 306, the system will continue to wait for the recovery item request. If there is a match between the lost item description and recovery item description at 310, a shipping request may be transmitted to shipper at 312. The lost item and the customer may be matched using any known methods. For example, categories in the lost item report and recovery item request may be matched. In another example, the lost item and the customer may be matched by using filters (as illustrated in FIG. 7C), keyword search, and other matching methods.

Referring to FIG. 2B, the method 200 may start with the receipt of a lost item report at 202 from an establishment to the recovery server. A determination may be made whether the lost item report includes client or customer information at 204. If no client or customer information is provided at 204, the method may continue to wait for the customer information. If customer information, such as an electronic mail address, phone number, and the like, is included in the lost item report at 204, a recovery notification may be transmitted to the customer at 206. In one embodiment, the recovery notification may inform the customer that their lost item has or has not been located. The recovery notification may be transmitted to the customer through any known means such as a text to a mobile phone, electronic mail message, and the like. In one embodiment, the notification may include a customized and/or personalized message to the client. For example, the notification may include a customized pre-formatted response that is transmitted to the client. In another example, the message may be a text, audio, attachment or any other type of notification message. In still another embodiment, after a pre-determined period of time (e.g. 30 days, 2 months, 3 months, and the like) the customized and/or personalized message may be a notification to the client that the item was not recovered.

The recovery server may monitor the recovery notification (or any other transmission to the client) to determine whether and when the client or customer viewed the recovery notification. When the client has viewed the recovery notification, the status indicator (as discussed with reference to FIG. 7C) may be updated to reflect that the customer was contacted. Additionally, the recovery server 108 may notify the establishment sever that the client was notified.

If the lost item was recovered, the recovery notification may include an option to have the lost item shipped to back to client, held at the establishment for pick-up by client, or a rejection to not have the lost item shipped back to client. If a request to not have the recovered item returned to the customer is made at 208, a rejection notification may be transmitted to the establishment at 210. In one embodiment, the rejection notification may be a hold request to have the establishment hold the recovered item for pick-up by the customer. In another embodiment, the rejection notification may be a rejection to inform the establishment that the customer does not want the recovered item returned to them.

If a request to have the recovered item returned to the customer is made at 208, a shipping and payment options may be transmitted to the customer at 212. The customer or client may then select the preferred shipping method and provide payment information to pay for shipping costs. The shipping method may also include different shipping options such as the purchase of insurance, delivery confirmation, and the like.

A payment manager may be used to conduct financial transactions such as obtain customer financial information, verify credit card payments, verify coupon codes, and the like. In one embodiment, payment manager may be configured to communicate with a third party payment server to conduct the financial transactions. In another embodiment, payment manager may perform the financial transactions without the use of a third-party payment server. Upon payment of the shipping costs, recovery server may transmit the shipping selection and payment notification to establishment server.

Although illustrated with the use of payment manager and third party payment server, this is not intended to be limiting as payment for the shipping costs may be conducted by other methods. For example, establishment may contact client directly to have the costs charged to a credit card on file at the establishment. In another example, establishment may obtain payment information directly from client.

A shipment manager may be configured to communicate with a shipping server. Shipping server may be any company that performs shipping services such as UPS™, United States Postal Service, DHL™, FedEx™, common carrier, local delivery service, and any other service provider. Shipment manager may be configured to transmit a shipping request to shipping server. The shipping request may include a request for shipping documents and/or information such as a tracking number, cost and/or bill, receipt, and any other shipping information and/or documents. Shipping server may transmit the requested shipping documents to shipping manager.

Once the selected shipping option is received and payment is made at 214, the shipping documents and payment notification may be transmitted to the establishment at 216 to let it know how the customer would like the recovered item to be shipped and that the customer has paid for the shipping costs. The shipping documents may be transmitted by any known means, for example via electronic mail, text, and the like. In another example, establishment can log into a website associated with the recovery server and access the shipping documents and/or information from the website. Establishment may then notify shipping company that the package or shipment needs to be picked up at the establishment by any known methods such as electronic mail, text message, use of the shipment company's web page, telephone call, or any other notification methods. In one embodiment, the printing of the shipping documents may automatically notify the shipping server that a package is ready for pickup at establishment.

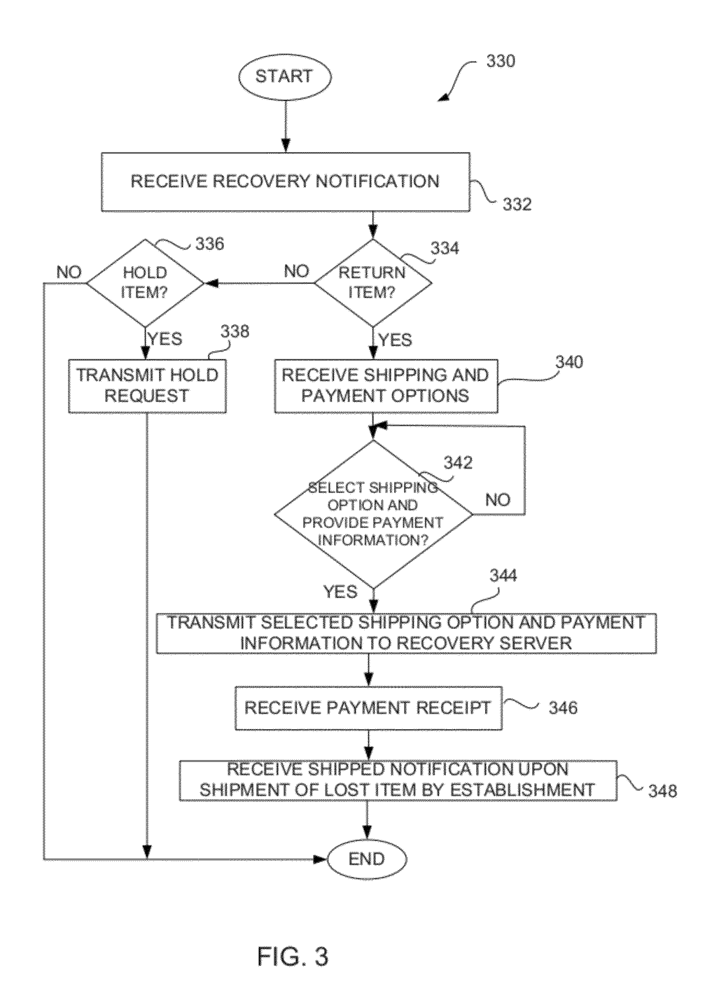

FIG. 3 illustrates an example of a client-side method for recovering lost items. The method 330 beings with the receipt of a recovery notification at 332. The recovery notification may be received at any computing device such as a computer, laptop, media device, mobile telephone, netbook, personal data assistant, and the like. The recovery notification may inform the customer or client that their lost item has been recovered. The recovery notification may include an option to have the lost item shipped to back to client, held at the establishment for pick-up by client, or a rejection to not have the lost item shipped back to client.

If the customer would not like the item to be returned at 334, a determination is made whether the customer would like the item to remain on hold at 336. If the customer would like to pick up the recovered item, the customer may transmit a hold request at 338 to the establishment to have the establishment hold the recovered item for pick-up by the customer. If a determination is made that the customer does not want the item to be held at 336, the method 330 may end as the customer most likely does not want the recovered item returned. Once the customer selects an option, a status indicator (e.g. status indicator 732 illustrated in FIG. 7C) in the lost item report may be automatically updated to reflect the customer's section.

In one embodiment, if it is determined that the customer would like the item returned at 335, shipping and payment options may be received at 340. A status indicator may also be automatically updated to record that the customer has provided a shipment selection and/or has paid for the recovered item to be shipped back to him. The client may select a preferred shipping method and provide payment information to pay for shipping costs. The shipping method may also include different shipping options such as the purchase of insurance, delivery confirmation, and the like. Once the shipping option and payment information is received at 342, the selected shipping method and payment information may be transmitted to the recovery server at 344 and a payment receipt showing payment in full may be received at 346. Once the establishment ships the recovered item, a shipped notification may be received at 348.

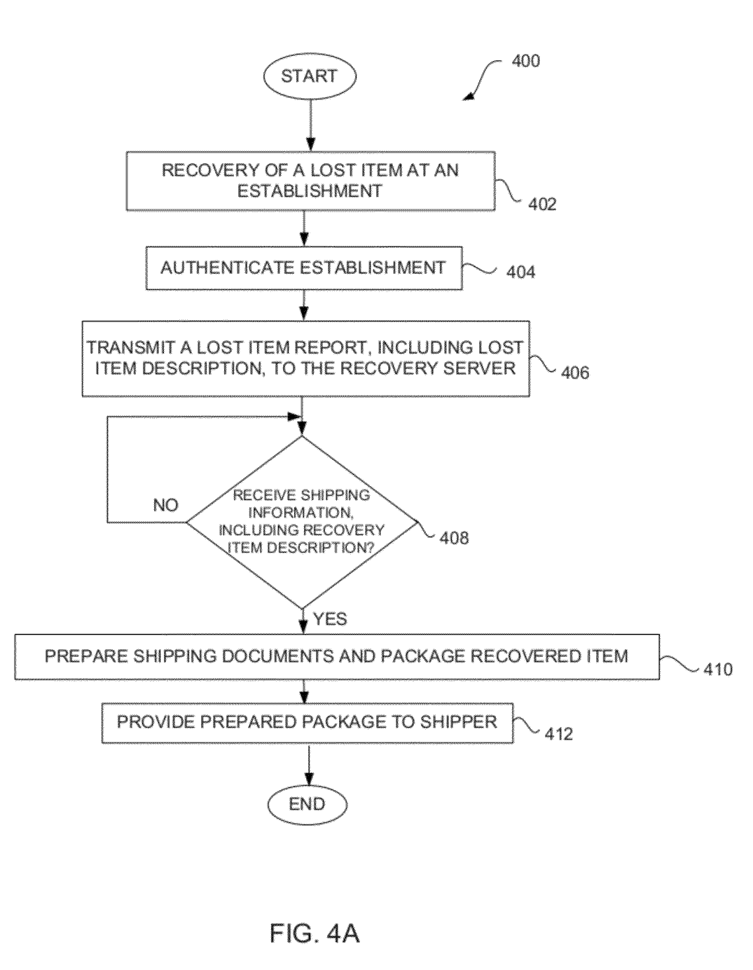

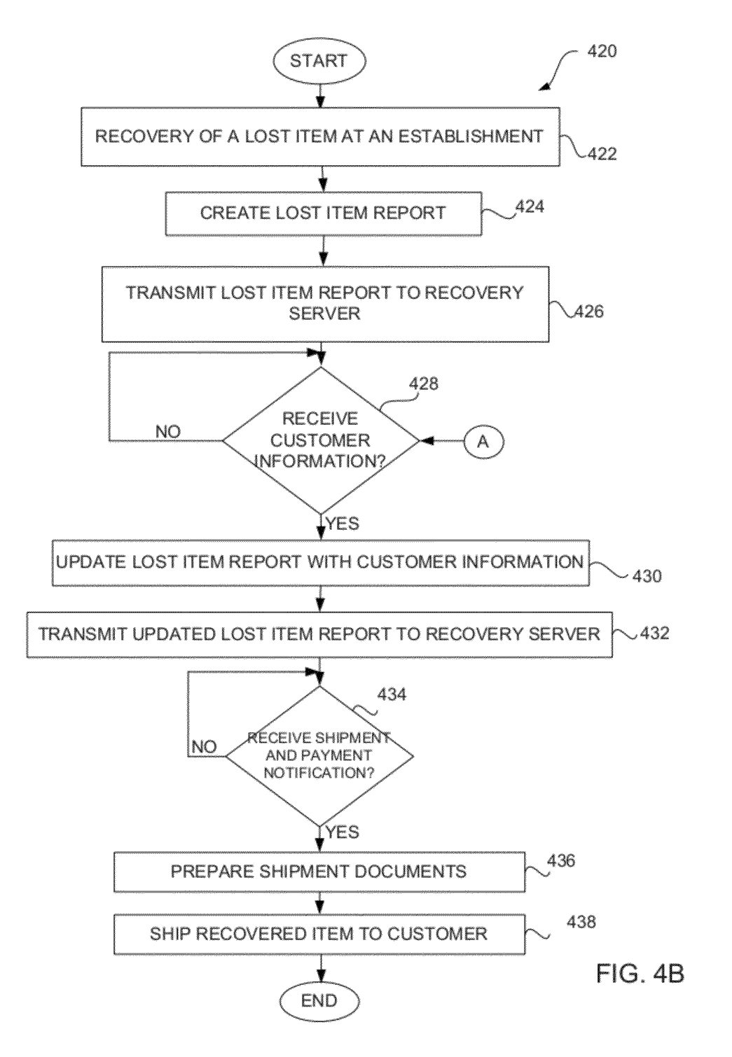

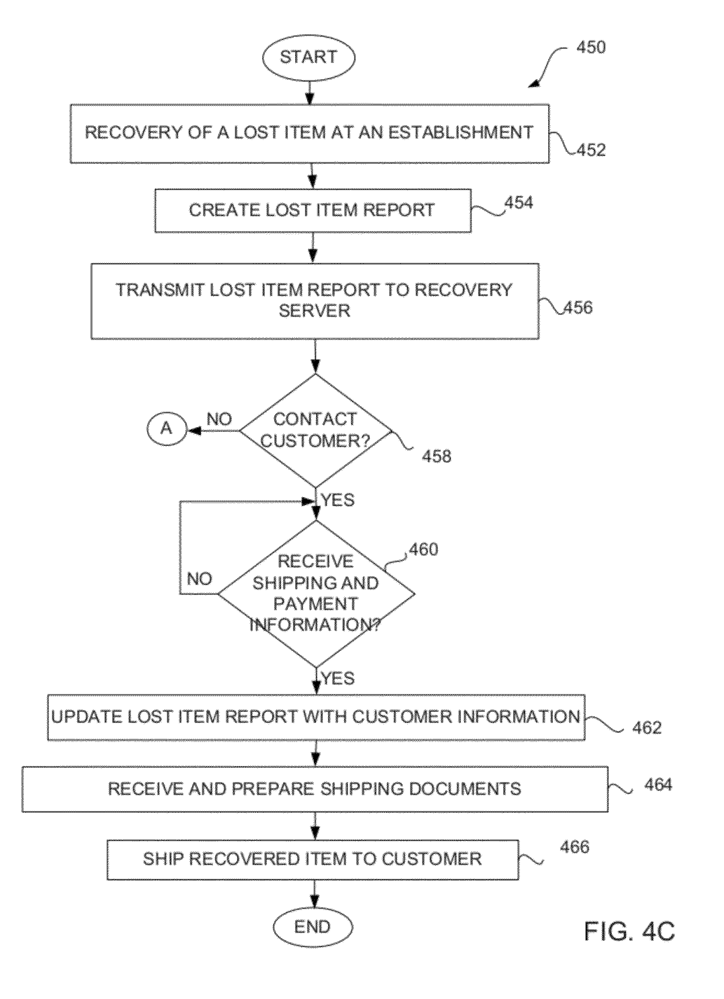

FIGS. 4A-4C illustrates another example of a method for recovering lost items. Referring to FIG. 4A, method 400 may start with the recovery of a lost item at an establishment at 402. Establishment may be authenticated at 404. Authentication may require the establishment to log into recovery server using an identification and/or password. However, any known means or methods for authenticating a user may be used. Additionally, in one embodiment, different security levels may be implemented for an establishment. For example, different security levels may be accessed based upon the passwords and/or identification used to authenticate the user. However, any type of method may be used to allow access to different levels of information. For example, access to client information may require a different password and/or identification than access to view a lost item report.

A lost item report, including lost item description, may be transmitted to the recovery server at 406. Lost item description may include lost item description such as the location of where the item was found, detailed description of the item, such as color, shape, manufacturer, client contact information, current storage location of the lost item and other descriptive information. The lost item description may also include an image of the lost item to enhance or increase the chances for identification of the lost item.

If shipping documents and/or information is received for a lost item, including recovery item description, at 408, establishment may prepare the shipping documents and package the recovered item at 410. Shipping documents and/or information may include such as a tracking number, cost and/or bill, receipt, and any other shipping information or documents. The shipping information may include the recovery item description to allow establishment to determine which item was recovered. Establishment may then provide the package to a shipper at 412.

Referring now to FIG. 4B, method 420 may begin with the recovery of a lost item at an establishment at 422. The establishment may then create a lost item report at 424. Lost item description may include lost item description such as the location of where the item was found, detailed description of the item, such as color, shape, manufacturer, client contact information, current storage location of the lost item and other descriptive information. The location of where the item was found may include a business name, room number, seat number, and/or additional location data of where the item was located. The lost item description may also include an image of the lost item to enhance or increase the chances for identification of the lost item. The lost item report may then be transmitted to the recovery server at 426.

A determination may be made whether customer information is received at 428. In one embodiment, if enough data and information about the lost item is collected, the establishment may attempt to proactively contact the customer to inform them of the lost item. For example, if the lost item is a wallet with an identification card, the establishment may attempt to contact the customer. In another embodiment, the customer themselves may contact the establishment inquiring about the lost item.

If customer information is received at 428, the lost item report may be updated with the customer information at 430. The updated lost item report may then be transmitted to the recovery server at 432.

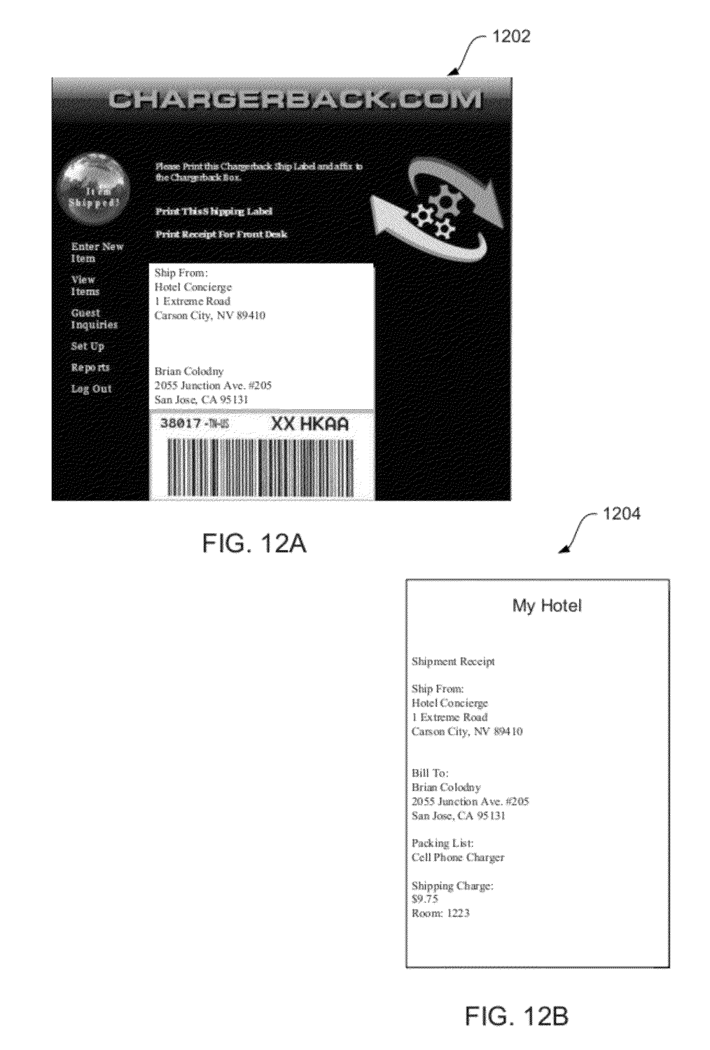

A determination is then made whether shipment and payment notification is received at 434. If a selected shipment option and payment notification is received at 434, establishment may prepare shipment documents at 436. Shipment information and/or documents may be obtained from recovery server. The shipment information and documents information such as a tracking number, cost and/or bill, receipt, and any other shipping information and/or documents necessary to prepare and ship a package as further illustrated in FIGS. 12A and 12B. The recovered item may then be packaged and shipped to the customer at 438.

Referring now to FIG. 4C, the method 450 may begin with the recovery of a lost item at an establishment at 452. The establishment may then create a lost item report at 454. Lost item description may include lost item description such as the location of where the item was found, detailed description of the item, such as color, shape, manufacturer, client contact information, current storage location of the lost item and other descriptive information. The location of where the item was found may include a business name, room number, seat number, and/or additional location data of where the item was located. The lost item report may then be transmitted to the recovery server at 456. The lost item description may also include an image of the lost item to enhance or increase the chances for identification of the lost item.

A determination may be made whether to contact the customer at 458. In one embodiment, if enough data and information about the lost item is collected, the establishment may attempt to proactively contact the customer to inform them of the lost item. For example, if the lost item is a wallet with an identification card, the establishment may attempt to contact the customer. If it is determined that the customer is not to be contacted at 458, the method may continue at “A” in FIG. 4B.

If the customer is contacted at 458, a determination may be made whether shipping and payment information is received at 460. For example, once the customer is contacted, the customer may be provided the opportunity to select a shipping option and provide payment information to pay for the shipping costs. The establishment may then update the lost item report with the customer information at 462 including the selected shipping option and payment information. However, if no shipping and payment information is received at 460, the method continues to wait for the shipping and payment information.

Once the updated lost item report is transmitted, the establishment may receive and prepare the shipping documents at 464. The shipping documents may be transmitted by any known means, for example via electronic mail, text, and the like. In another example, establishment can log into a website associated with the recovery server and access the shipping documents and/or information from the website. The Establishment may then be able to print shipping labels (i.e. plain paper or label stock), assign a tracking number, print a receipt for billing purposes, and conduct any other requirements to efficiently ship the recovered item to the customer at 466.

### Example

This example is for illustrative purposes only and is not intended to be limiting. For example, although illustrated with the establishment being a hotel, establishment may be any other location such as a cruise ship, airline, casino, car rental company, seminar, convention, and the like.

Brian reserves a room at My Hotel using their website for one night. Brian arrives at My Hotel late in the evening after a long client meeting and is assigned room 1223. Unfortunately, Brian is only able to get 3 hours of sleep before he has to wake up to catch a flight home. Brian is so tired that he forgets his cell phone charger in the room.

Later that morning as the housekeeper is cleaning the room, she finds the cell phone charger. In one embodiment, the housekeeper can turn in the cell phone charger to the lost and found department (L&F) once her shift is complete. In another embodiment, the housekeeper may use a portable mobile device to report the lost cell phone charger. For example, the housekeeper (as opposed to L&F) may input lost item description information, including at least one image of the lost item, and create the lost item report. In still another embodiment, the housekeeper may only have limited access (as discussed with reference to FIG. 4A) to input a limited amount of lost item description information (e.g. image of the lost item and/or location of the lost item).

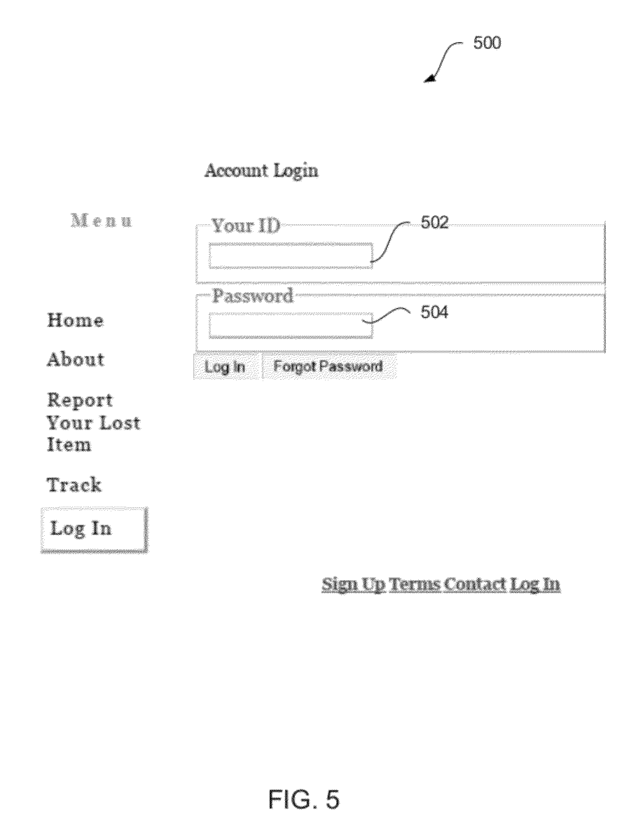

FIG. 5 illustrates an example screen shoot of a log-in screen. To authenticate the establishment, the log-in screen 500 requires an identification 502 as well as a password 504. However, this is not intended to be limiting as other authentication and/or verification methods may be used to authenticate the establishment such as speech recognition, retinal and/or fingerprint scans, and the like. The authentication and/or verification may be conducted by the recovery server (e.g. recovery server 108 illustrated in FIG. 1) or any third party server.

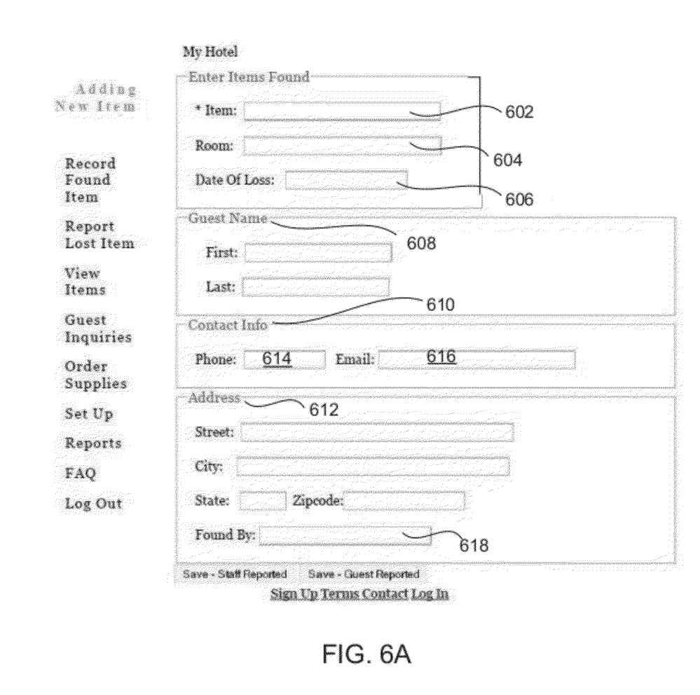

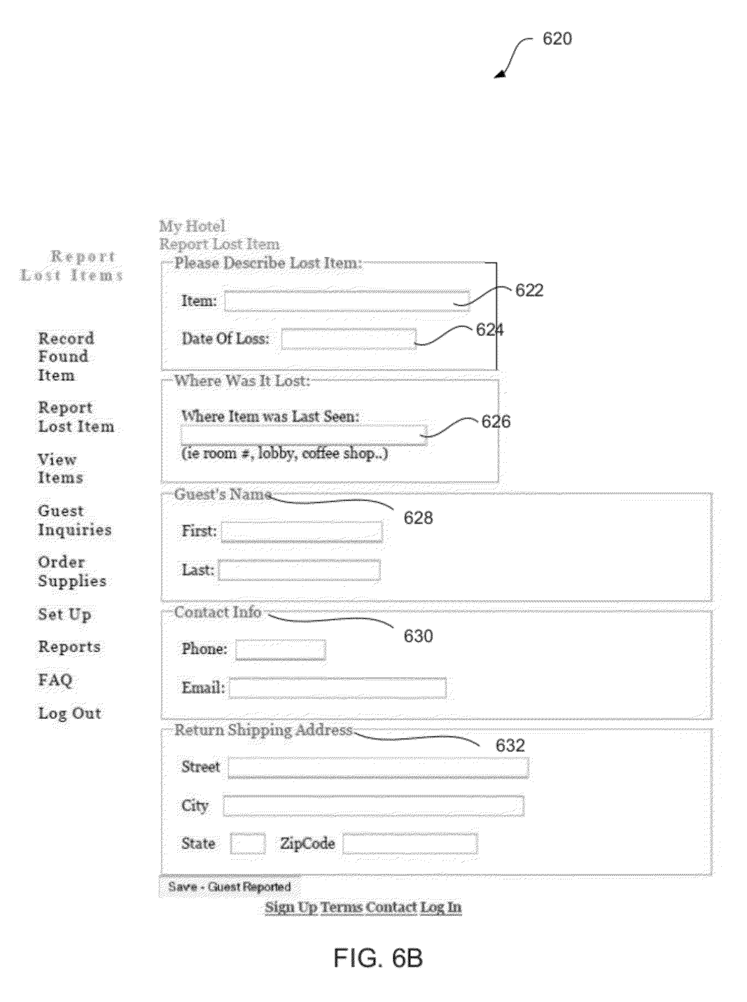

FIGS. 6A-6B illustrate example screen shots of a lost item report. Referring to FIG. 6A, after being authenticated, L&F may create a lost item report 600. The lost item report 600 may include lost item description such as the location of where the object was found, detailed description of the item 602, such as color, shape, additions, date when the object was found 606, current storage location of the lost item, and other descriptive information. The location of where the item was found may include a business name, room number 604, and/or additional location data of where the item was located such as a conference room and the like. The lost item description may also include an image of the lost item to enhance or increase the chances for identification of the lost item.

The name of the person that found the lost item 618 may also be included. If additional customer information is readily available, the customer name 608, contact information 610 (e.g. phone number 614, electronic mail address 616, and other contact information), and address 620 may be included in the lost item report 600.

Prior to the housekeeper completing her shift, Brian realized that he forgot the cell phone charger in the room and calls My Hotel. Referring now to FIG. 6B, Brian informs L&F of the lost cell phone charger and L&F inputs as much information as they can into the lost item report 620. For example, L&F may log a description of the item 622, such as color, shape, manufacturer, date when the object was lost 624, location of where the object was last seen 626, current storage location of the lost item, and other descriptive information. The lost item description may also include an image of the lost item to enhance or increase the chances for identification of the lost item. Customer information may also be included such as the customer name 628, contact information 630, return shipping address 632, and any other desired or necessary information.

While L&F is logged into their account at recovery server, they are able to obtain various reports. In one embodiment, recovery server may manage and control the lost and found inventory for the hotel. For example, recovery server may manage a list of lost items found by the hotel as well as a list of recovered and returned items. Recovery server may control the lost and found inventory for My Hotel by automatically deleting lost times from the lost item list once the item is recovered and/or returned to its rightful owner and/or post the recovered items to a recovered and returned item list.

FIGS. 7A-7B illustrate example screen shot for reports and services provided by recovery server. FIG. 7A illustrates an example screen shot for the various reports that may be provided to an establishment by recovery server. Although illustrated with specific reports, this is not intended to be limiting as any type of report may be generated for the establishment for any reason, such as documentation, financial, and the like. For example, recovery server (such as recovery server 108 in FIG. 1) may provide a profit reports 702, total item shipped reports 704, inventory reports 706, and tracking reports 708. Profit reports 702 may report the amount of profits to the establishment by using the disclosed invention as compared to shipping the recovered products without using the disclosed invention. This may illustrate the benefits of using the disclosed invention to the establishment. The total item shipped reports 704 may indicate the number of lost and recovered items that have been shipped to clients. Inventory reports 706 may be a list of lost items currently at the establishment. In one embodiment, the inventory report 706 may also include the estimated value for each item. In another embodiment, the inventory reports 706 may also sort the inventory by criteria such as type, description, quantity, estimated value, or by any other criteria. An example screen shot of an inventory report 720 is further illustrated in FIG. 7B. Lastly, tracking reports 708 may provide tracking information for shipped recovered items.

FIG. 7B illustrates an example inventory report. Once L&R transmits the lost item report, it may appear in the inventory report 720. As illustrated, on Jul. 3, 2011, in room 1223, Brian Colodny lost a cell phone charger 722. Other lost items include a key chain left in room 122222 by Adrienne Yeung on Jul. 10, 2011 724 or a vodka bottle left in conference room 5 by Mac Mcl on Aug. 17, 2011 726.

In one embodiment, the inventory report 720 may be filtered to obtain a customized report. Referring to FIG. 7C, the criteria by which the user may filter the lost item list may be presented in a drop down list 730. For example, the list may be filtered by items that were reported by guests, items that were reported by staff, items in which the guests were notified by email, items in which the guests were notified by a phone call, items which have been shipped, items on hold, and the like. Each filter may be associated with a status indicator 732. The status indicator 732 may also be located in the inventory report 720 under “Status” 734 as illustrated in FIGS. 7B and 7C.

The status indicators 732 may also provide for evidence of the chain of custody of the lost item. Chain of custody may be important for some establishments, such as hotels, casinos, and the like. As such, the use of status indicators 732 may make it easier to track the lost item through its progress from the time it was found, until the time the recover item is shipped to the customer or client. The status indicators 732 may also be used to enable or disable selection options for the client and/or establishment. For example, if a “Shipped To Client” status indicator is selected, the “Ship It” indicator may be disabled.

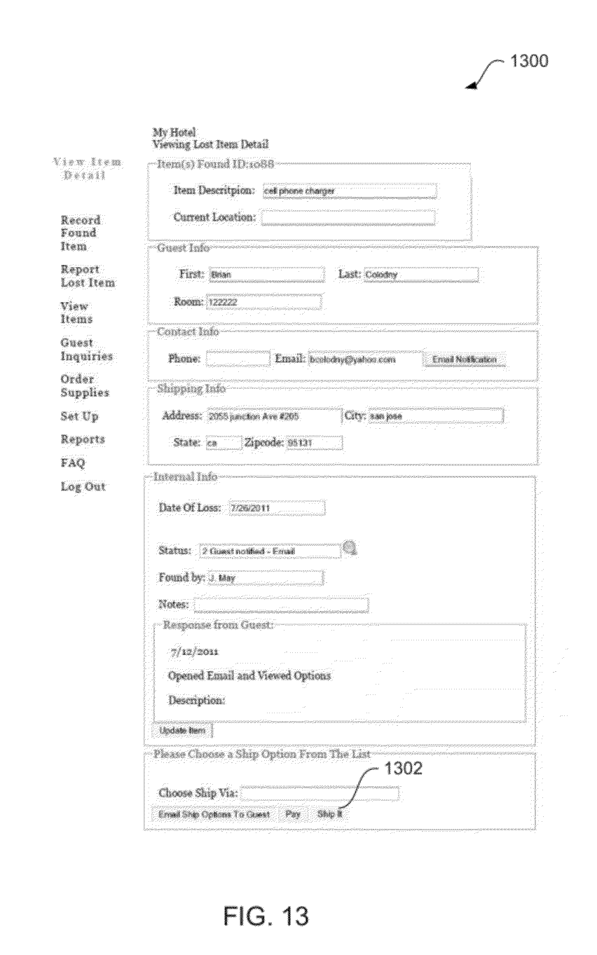

In one embodiment, the status indicators 732 may be automatically updated upon a transaction. For example, if the “Ship It” indicator is depressed (as illustrated in FIG. 13), the status indicator may be automatically updated to indicate that the recovered item is shipped. In another example, if customer information is inputted and the lost item report is updated, the status may automatically be updated to indicate that the client was contacted. In yet another example, the status indicator may be automatically updated when the client has viewed or made a selection from the recovery notification.

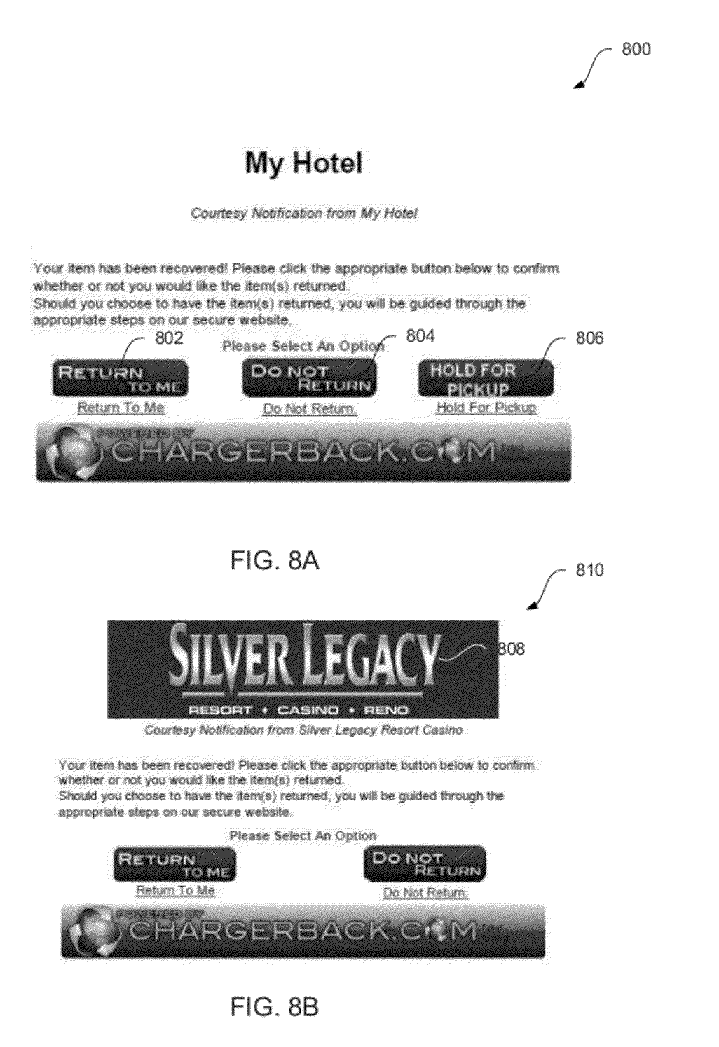

Once the lost item report is transmitted to the recovery server and the lost item report includes Brian's contact information, Brian may receive a recovery notification that his cell phone charger is found. The recovery notification may be transmitted from the recovery server to Brian's email address, text messaged to Brian's portable electronic device, or any other way to transmit a recovery notification. FIGS. 8A-8B illustrate example screen shots of a recovery notification. Referring to FIG. 8A, the recovery notification 800 may display several options: 1. have the recovered item returned 802; 2. not have the recovered item returned 804; and 3. have the recovered item held for pick up 806.

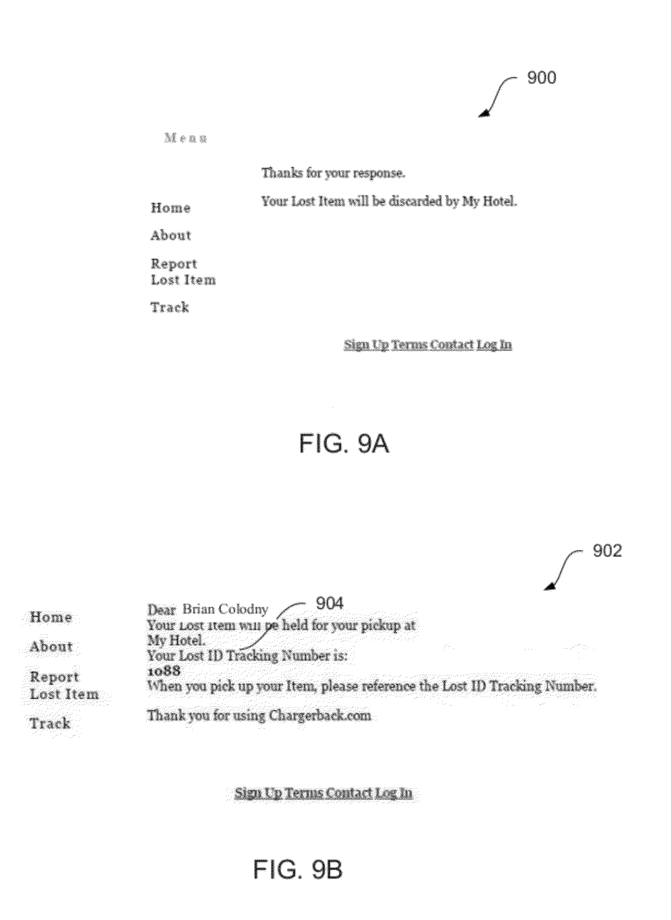

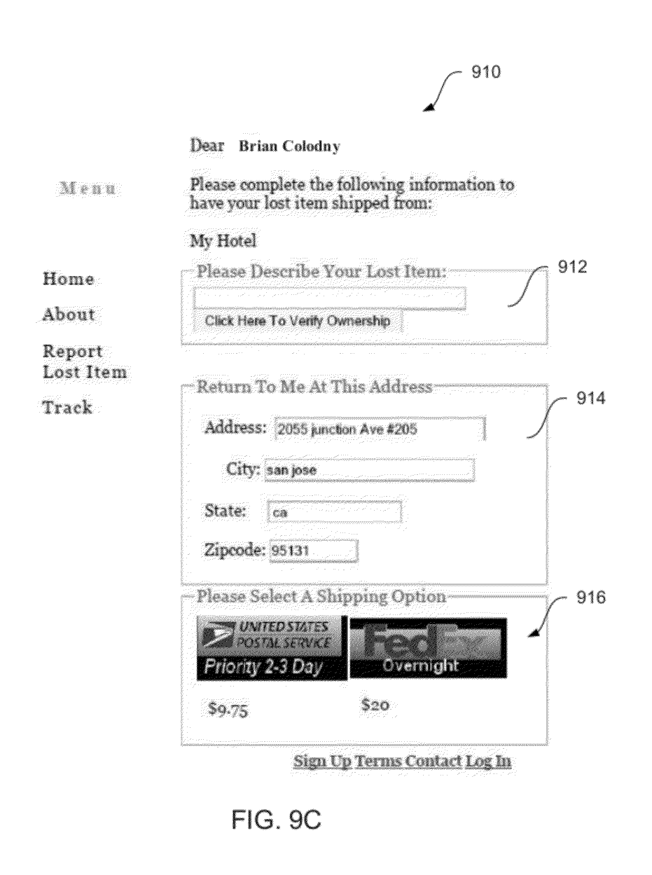

The recovery notification may be customized to the establishment such as including the establishment logo, tag lines, colors, and any other indicia necessary or desired by the establishment to customize the coupon. Referring to FIG. 8B, the recovery notification 810, as illustrated, is customized for Silver Legacy Hotel and Casino in Reno, Nev. including the logo 808, color scheme (not illustrated), and any other establishment requirements. In one embodiment, the recovery notification may also have a unique code embedded in the notification to automatically direct Brian to a specific location in the recovery server as discussed with reference to FIG. 9A-9C.

The recovery server may monitor the recovery notification (or any other transmission to the client) to determine whether and when the client or customer viewed the recovery notification. When the client has viewed the recovery notification, the status indicator (as discussed with reference to FIG. 7C) may be updated to reflect that the customer was contacted. Additionally, the recovery server 108 may notify the establishment sever that the client was notified.

FIGS. 9A-9C illustrate example screen shots of responses to a selection of the recovery notification. Brian may decide that he would rather buy a new cell phone charger and opt to not have the cell phone charger returned to him. As such, he may select the “Do Not Return” indicator (e.g. “Do Not Return” indicator 804 illustrated in FIG. 8A). Upon that selection, Brian may receive a “Do Not Return” confirmation 900 as illustrated in FIG. 9A. The “Do Not Return” confirmation 900 may indicate that My Hotel will discard the cell phone charger. In one embodiment, a unique code embedded within the recovery notification will direct Brian to a specific location in the recovery server to inform Brian that the establishment will discard the cell phone charger.

On the other hand, Brian may decide that since he will be back at My Hotel within a few days, he may opt to select the “Hold For Pickup” indicator (e.g. “Hold For Pickup” 806 illustrated in FIG. 8A) and pick up the cell phone charger when he returns to My Hotel. Upon that selection, Brian may receive a “Hold” confirmation 902 as illustrated in FIG. 9B. The “Hold” confirmation 900 may indicate that My Hotel will hold the item for pick up. The “Hold” confirmation 900 may include a tracking number 904 that tracks the recovered item. The tracking number 904 may be used when querying the recovery server for lost item description information for the lost or recovered item. In one embodiment, a unique code embedded within the recovery notification will direct Brian to a specific location in the recovery server to inform Brian that the establishment will hold the cell phone charger for him.

In another embodiment, the “Hold” confirmation 900 may also include an expiration date until which My Hotel will hold the recovered item. For example, My Hotel may determine that they will only hold recovered items for 30 days before disposing of the recovered item. In another embodiment, My Hotel may transmit a reminder “Hold” confirmation after a predetermined period of time. The reminder may include the various options for the customer to select as the customer may have changed his mind about having the recovered item returned to him.

In the end, Brian may decide that he would like his cell phone charger shipped back to him. Thus, he may select the “Return To Me” indicator (e.g. “Return To Me” 802 illustrated in FIG. 8A). Upon detecting that selection, Brian may be directed to a shipping option and payment screen as illustrated in FIG. 9C. In one embodiment, the shipping option and payment screen 910 may require Brian to verify his ownership of the recovered item 912. In another embodiment, Brian may not be required to verify his ownership of the recovered item. Various methods to match the owner and the recovered item may be used. For example, Brian may be required to sign in using the same identification and password as used when signing into his My Hotel account. In another example, Brian may input a description of the recovered item 912, tracking number, or any other identifiable keywords and it may be matched with the items in My Hotel's recovery list.

Brian may then input a return address 914 as well as select his preferred shipping method 916. The shipment costs may also be displayed. For example, if the cell phone charger is returned via the United States Postal Service, Priority 2-3 days, it will cost Brian $9.75. However, if Brian would like the cell phone charger to be shipped FedEx Overnight, the cost will be $20.

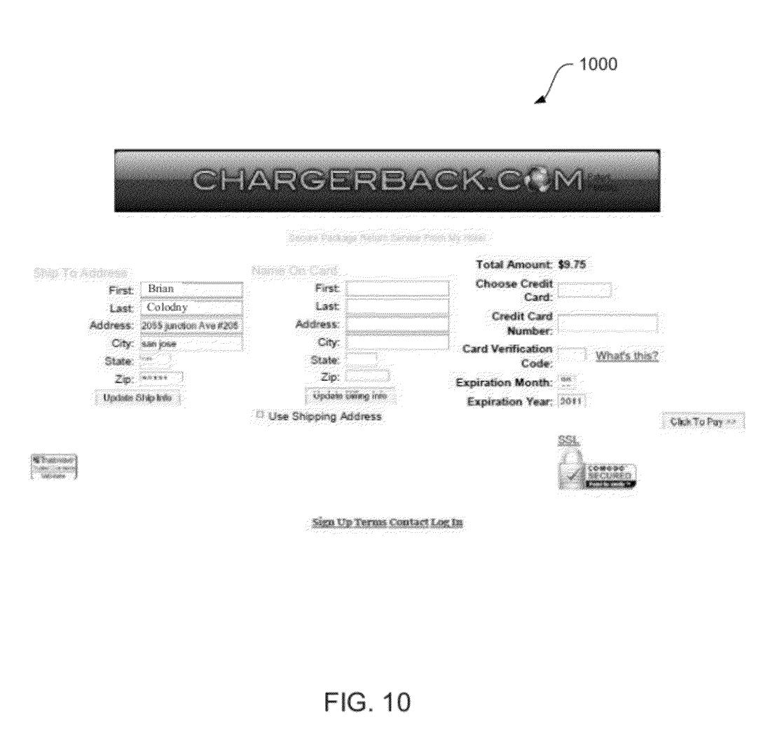

Once the shipment method is selected and the return address is transmitted, Brian may be directed to a payment information page to pay for the shipping costs. FIG. 10 illustrates a same screen shot of a payment method. Brian may be presented with a payment screen 1000 to obtain financial information such as credit card information, bank account information, or any other financial methods to pay for the incurred costs. In one embodiment, recovery server may utilize a third party payment server (e.g. third party payment server 126 illustrated in FIG. 1) to handle the financial transactions.

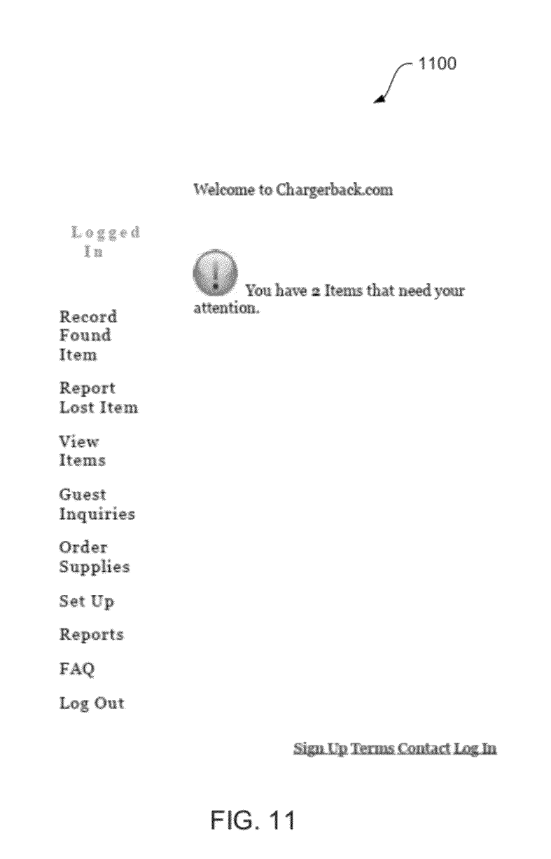

Once Brian submits his shipping option and payment, recovery server may notify My Hotel. FIG. 11 illustrates a screen shot of an example alert notification for My Hotel. The alert notification 1100 may inform the establishment of a variety of issues that need attention. As illustrated, the establishment has 2 items that need to be addressed. For example, an alert may be a notification that a customer selected and paid for their recovered items to be shipped to them. In another example, the alert may be a notification that a customer sent them an inquiry to follow-up on the status of their recovered items. In still another example, the alert may be a notification that a customer received the wrong recovered item. In yet another example, the alert may be a notification that a customer does not want their recovered item returned to them. In another example, the alert may be a notification of a new or changed item description that was transmitted to the establishment from a client or customer. The alerts may also be any other issues such as reminder for the establishment to renew their account, and the like.

When alerted, L&F may prepare the cell phone charger for shipment back to Brian. L&F may insert the cell phone charger into the appropriate shipping package based upon Brian's selected shipping option. L&F may then print out the shipping documents to attach to the shipping package. FIGS. 12A and 12B illustrate example shipping documents. FIG. 12A illustrates an example shipping label 1202 and FIG. 12B illustrates an example shipping bill and/or receipt 1204. Establishment may then notify shipping server that the package or shipment needs to be picked up at the establishment by any known methods such as electronic mail, text message, XML, SMS, use of the shipment company's web page, telephone call, or any other notification methods. In one embodiment, the printing of the shipping documents may automatically notify the shipping server that a package is ready for pickup at establishment.

FIG. 13 illustrates an example detailed lost item report. In one embodiment, shipping documents are provided once L&F clicks the “Ship It” button 1302 of the detailed lost item report 1300. In another embodiment, shipping documents are automatically provided to the establishment.

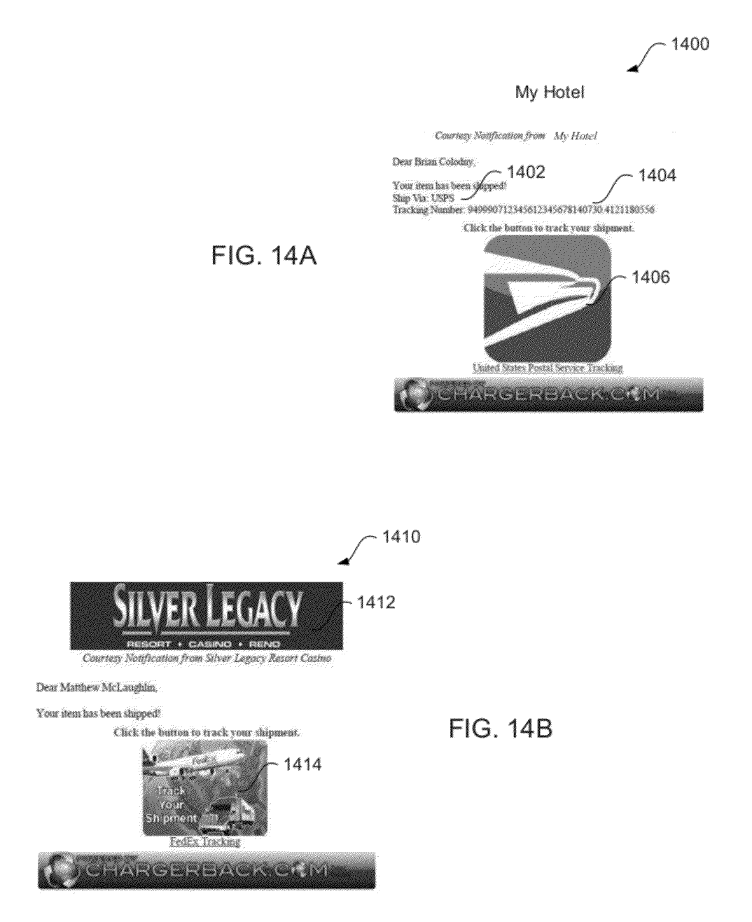

Once the package is prepared and delivered to the shipping company, Brian may receive a shipped notification to inform him that his cell phone charger is being shipped back to him. FIGS. 14A-14B illustrate example screen shots of shipment notifications. Referring to FIG. 14A, the shipped notification 1400 may notify Brian that his cell phone charger was shipped via the United States Postal Service (USPS) 1402. The shipped notification 1400 may also include a tracking number 1404. In one embodiment, Brian may click the USPS logo 1406 and be automatically directed to the USPS website to track his package. In one embodiment, the shipped notification may also include other shipping options such as the purchase of insurance, delivery confirmation, and the like.

Referring to FIG. 14B, similar to the coupon and recovery notification, the shipped notification may also be customized to the establishment. The shipped notification 1410 may be customized to include the establishment logo, color scheme, tag lines, or any other customized desired by the establishment. As illustrated, the shipped notification 1410 may be customized for Silver Legacy 1412. Additionally, similar to FIG. 14A, the user may select the shipping company logo 1414 and be automatically directed to the shipping company's website to track their package. A physical coupon or other establishment promotional material may also be included with the shipped package.

As illustrated in the example above, the invention may provide for the quick and economical return of lost items, such as chargers, cell phones, and other important valuables left at an establishment. Among other things, the invention may provide for: (i) automatic notification to a shipper, such as FedEx, UPS, the USPS, or any other shipping company; (ii) automatic billing to the hotel shipper account; (iii) ability to print shipping documents, such as shipping labels and receipts; (iv) automatic issuance of a shipper tracking number; (v) automatic recovery notification to the client, including the tracking number; (vi) convenient billing to the client and/or establishment; and (vii) allows the establishment and client to track the shipment of the recovered item.

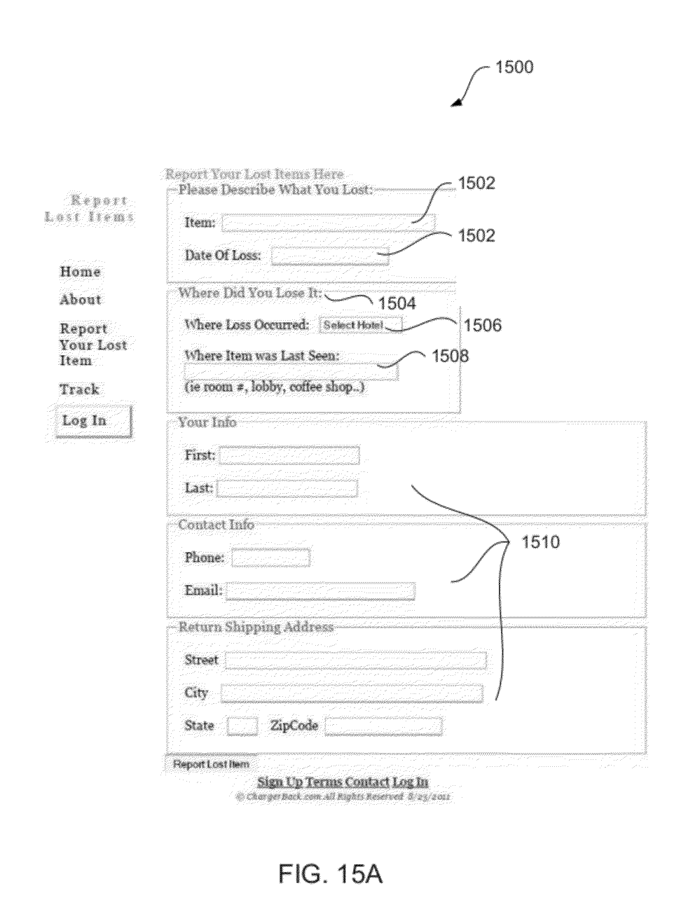

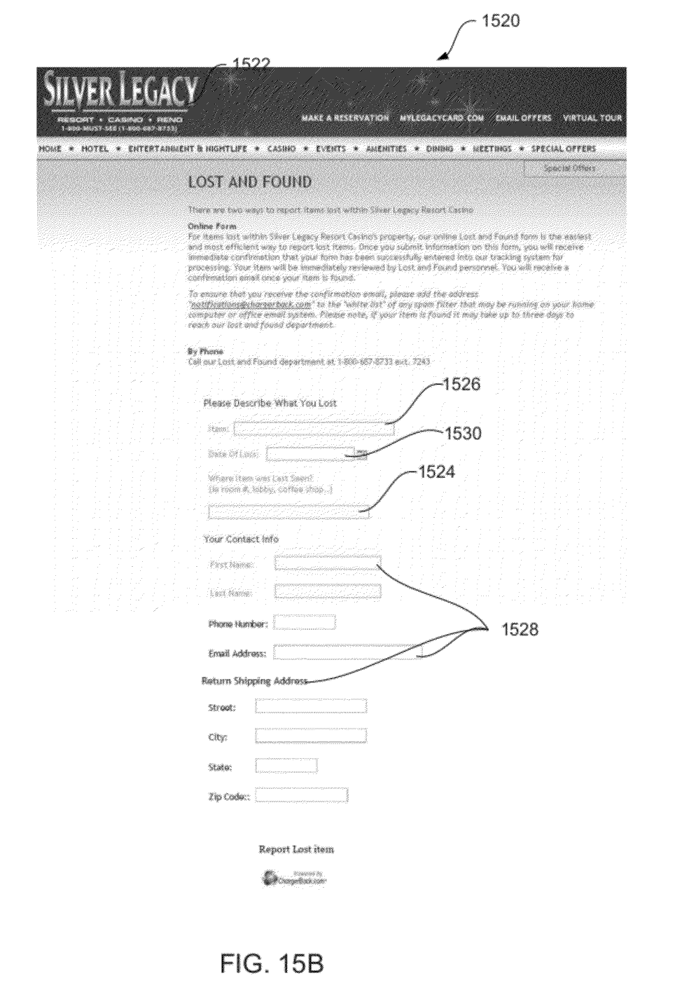

FIGS. 15A and 15B illustrate example screen shots of a recovery item request. Referring to FIG. 15A, the recovery item request may be completed and transmitted through use of the recovery server (e.g. recovery server 108 illustrated in FIG. 1). The recovery item request 900 may be submitted by a client for an item that may have been left behind or lost at an establishment. The recovery item request 1500 may require the client to input information about the lost item as well as client information. For example, the lost item information may include a description of the item such as a name and/or detailed description of the item, such as color, shape 1502, when the item was lost 1512, and the location of where the item was lost 1504. The location 1504 may include a drop down menu 1506 for the user to select where the loss occurred. For example, the drop down menu 1506 may include a list of hotels, cruise ships, store names, rental car companies, and other establishments that the client may select from. Lastly, the client may include client information 1510 such as contact information, return shipping address, and any other necessary or desired client information.

Referring to FIG. 15B, the recovery item request may be completed and transmitted via the establishment server (e.g. establishment server 104 illustrated in FIG. 1). As illustrated, the establishment server is Silver Legacy 1522. The client may complete the recovery item request via the establishment's website and include recovery item descriptions such as the date of when the item was lost 1530, location of where the item was lost 1524, detailed description of the item 1526, such as color, shape, additions, client contact information, and other descriptive information. The location of where the item was lost may include a room number, seat number, and/or additional location data of where the item was lost. The recover item request may also include an image of the lost item to enhance or increase the chances for identification of the lost item. Additionally, the recovery item request may also include client contact information 1528 such as name, phone number, email address, return shipping address, and any other necessary information.

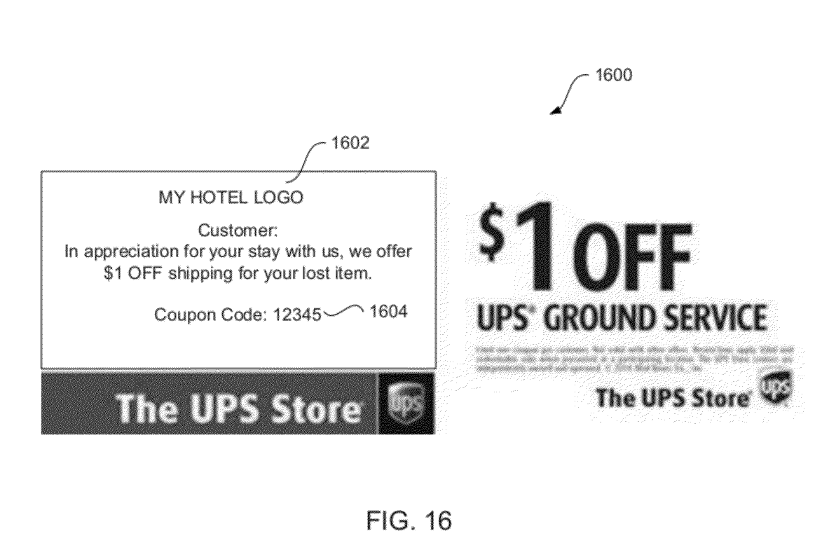

FIG. 16 illustrates an example coupon provided by an establishment. The coupon 1600 may be customized to the establishment such as including the establishment logo 1602, tag lines, colors, and any other indicia necessary or desired by the establishment to customize the coupon 1600. The coupon 1600 may be provided to customer or client to provide a discount on the return of their lost times, such as a discount on shipping costs, hotel stays, buffet, show tickets, and the like. The coupon 1600 may be provided to the client at different times. In one example, the coupon may be transmitted to the client device (e.g. client device 102a-n illustrated in FIG. 1) concurrently with, before, or after a recovery notification is transmitted to client device. In another example, a physical coupon may be provided to the customer upon check-in at the establishment or event. The physical coupon may have a coupon code 1604 that the customer may enter to obtain the discount. In still another example, the coupon may be provided to the client device 102a-n after logging into a website.

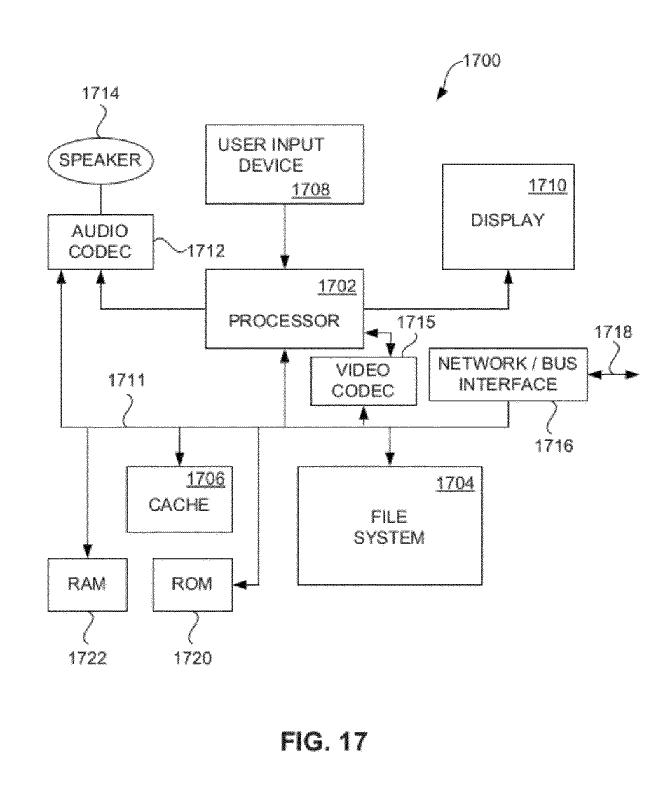

FIG. 17 illustrates a block diagram of a computing device 1700 according to one embodiment. The computing device 1700 can represent circuitry of a representative computing device (e.g. client device, recovery sever, shipping server, third party payment server, establishment server) described and illustrated in FIG. 1.

The computing device can be designed to primarily stationary or can be portable.

The computing device 1700 includes a processor 1702 that pertains to a microprocessor or controller for controlling the overall operation of the computing device 1700. The computing device 1700 stores media data pertaining to media items in a file system 1704 and a cache 1706. The file system 1704 is, typically, semiconductor memory (e.g., Flash memory) and/or one or more storage disks. The file system 1704 typically provides high capacity storage capability for the computing device 1700. However, since the access time to the file system 1704 can be relatively slow, the computing device 1700 can also include the cache 1706. The cache 1706 is, for example, Random-Access Memory (RAM). The relative access time to the cache 1706 is typically shorter than for the file system 1704. However, the cache 1706 does not have the large storage capacity of the file system 1704. The computing device 1700 also includes a RAM 1720 and a Read-Only Memory (ROM) 1722. The ROM 1722 can store programs, utilities or processes to be executed in a non-volatile manner. The RAM 1720 provides volatile data storage, such as for the cache 1706.

The computing device 1700 may also include a user input device 1708 that allows a user of the computing device 1700 to interact with the computing device 1700. For example, the user input device 1708 can take a variety of forms, such as a button, keypad, dial, touch-sensitive surface, etc. Still further, the computing device 1700 includes a display 1710 (screen display) that can be controlled by the processor 1702 to display information to the user. A data bus 1711 can facilitate data transfer between at least the file system 1704, the cache 1706, the processor 1702, an audio coder/decoder (CODEC) 1712 and/or a video CODEC 1715.

In one embodiment, for example, if the computing device 1700 (e.g. client device 102a-n, establishment server 104 illustrated in FIG. 1) is a media player, the computing device 1700 may store a plurality of media items (e.g., songs, videos, podcasts, etc.) in the file system 1704. When a user desires to have the computing device play a particular media item, a list of available media items is displayed on the display 1710. Then, using the user input device 1708, a user can select one of the available media items. The processor 1702, upon receiving a selection of a particular media item, supplies the media data to one or more appropriate output devices. If the particular media item is encrypted, the particular media item is first decrypted as noted above, which could involve one or more layers of encryption. As an example, for audio output, the processor 1702 can supply the media data (e.g., audio file) for the particular media item to the audio CODEC 1712. The audio CODEC 1712 can then produce analog output signals for a speaker 1714. The speaker 1714 can be a speaker internal to the computing device 1700 or external to the computing device 1700. For example, headphones or earphones that connect to the computing device 1700 would be considered an external speaker. As another example, for video output, the processor 1702 can supply the media data (e.g., video file) for the particular media item to the video CODEC 1715. The video CODEC 1715 can then produce output signals for the display 1710 and/or the speaker 1714.

The computing device 1700 also includes a network/bus interface 1716 that couples to a data link 1718. The data link 1718 allows the computing device 1700 to couple to another device (e.g., a host computer, a power source, or an accessory device). The data link 1718 can be provided over a wired connection or a wireless connection. In the case of a wireless connection, the network/bus interface 1716 can include a wireless transceiver.

The various aspects, features, embodiments or implementations of the invention described above can be used alone or in various combinations. Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment”, “an embodiment”, “one example” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

What is claimed is:

1. A system for monitoring lost items, the system comprising:
a database configured to store lost item information, the lost item information pertaining to lost items that have been recovered at one or more establishments; and
a computing device operatively connected to the database, the computing device operable to:
receive lost item information for a given lost item that has been recovered at the one or more establishments;
entry of a lost item record for the given lost item into the database, the lost item record includes the lost item information for the given lost item;
browse or search the database to locate lost item of a current or prior patron of the one or more establishments; and
facilitating transmission of an electronic recovery notification to the current or prior patron when the lost item of the current or prior patron has been located in the database.

2. The system of claim 1, wherein the electronic recovery notification includes a plurality of return item options, the plurality of return item options include at least a hold item option, a return item to me option, and a do not return item option.

3. The system of claim 2, wherein the return item to me option includes at least one shipment option, the shipment options including links to initiate payment of shipment for return of the lost item to the current or prior patron.

4. The system of claim 3, wherein the computing device is operable to:
locate a coupon associated with the one or more establishments; and
provide the coupon to the current or prior patron,
wherein the coupon includes a coupon code to discount payment of the shipment for return of the lost item to the current or prior patron.

5. The system of claim 1, wherein the computing device is operable to:
facilitate acquisition of a shipment label for a selected on of the at least one shipment option.

6. The system of claim 1, wherein the computing device is operable to:
update a status of the lost item in the database.

7. The system of 6, wherein the status is automatically updated or manually updated in the database.

8. The system of claim 1, wherein the lost item information includes at least a description of the lost item, an image of the lost item, and where and when the lost item was found.

9. The system of claim 1, wherein the status of the lost item is one of: recovered item shipped, current or prior patron notified, lost item disposed, lost item recovered, recovered item on hold.

10. A method for maintaining a database pertaining to lost items, the method comprising:
providing a database configured to store lost item information, the lost item information pertaining to lost items that have been recovered at one or more establishments;
displaying a first graphical user interface that facilitates receipt of lost item information for a given lost item;
entry of a lost item record for the given lost item into the database, the lost item record includes the lost item information for the given lost item;
subsequently displaying a second graphical user interface for initiating a search of the database to locate a missing item of a current or prior patron of the one or more establishments; and
updating a status of the lost item provided that the searching locates the lost item in the database.

11. The method of claim 10, wherein the lost item information includes at least a description of the lost item, an image of the lost item, and where and when the lost item was found.

12. The method of claim 10, status of the lost item is one of: recovered item shipped, current or prior patron notified, lost item disposed, lost item recovered, recovered item on hold.

13. The method of claim 10, further comprising:
transmitting an electronic recovery notification message to the current or prior patron of the one or more establishments when the lost item of the current or prior patron has been identified in the database.

14. The method of claim 13, further comprises:
receiving an electronic shipment request initiated by the current or prior patron after having received the electronic recovery notification message.

15. The method of claim 13, further comprises:
generating a coupon associated with the one or more establishments; and
providing the coupon to the current or prior patron,
wherein the coupon includes a coupon code to discount shipment of a recovered item.

16. The method of claim 15, further comprises:
facilitating shipment of a recovered item corresponding to the located lost item in accordance with the electronic shipment request.

17. The method of claim 13, further comprising customizing the electronic recovery notification message prior to transmission to the current or prior patron.

18. The method of claim 10, further comprising:
transmitting an electronic no recovery notification message to the current or prior patron of the one or more establishments when the lost item of the current or prior patron has not been identified in the database.

19. The method of claim 10, wherein the updating further includes
automatically updating the status upon a predetermined event of the lost item.

20. The method of claim 10, wherein the updating further includes
manually updating the status upon a predetermined event of the lost item.
